(19) United States
(12) Patent Application Publication
(10) Pub. No.: US 2012/0311157 A1
(43) Pub. Date: Dec. 6, 2012

(54) INTEGRATED INFORMATION TECHNOLOGY SERVICE MANAGEMENT FOR CLOUD RESOURCES

(76) Inventors: Philip J. Erickson, Shoreview, MN (US); James Roffe, Blaine, MN (US); Mark Jeffrey Tadman, Mission Viejo, CA (US)

(21) Appl. No.: 13/152,349

(22) Filed: Jun. 3, 2011

(51) Int. Cl. G06F 15/173

(52) U.S. Cl. 709/226

(57) ABSTRACT

Systems and methods described herein use software adapters to provide integrated information technology service management (ITSM) for cloud resources. Software adapters in the cloud resources convert data format types of an input parameter received at a first software application in a backend computing device. An ITSM function of a second software application provides management for the cloud resources. The input parameter in a first data format type is converted by the software adapter to a second data format type, the second data format type supported by a second software application. The ITSM function of the second software application is executed using the input parameter in the second data format type, thereby providing an output of the ITSM function, the output including information and executable instructions for management of the cloud resources.

### TECHNICAL FIELD

The present disclosure relates to systems, methods, and computer programs for integrated information technology service management (ITSM) for cloud resources.

### BACKGROUND

The term “cloud computing” typically represents a seamless computing network, where backend computing devices handle most of the processing and storage functionalities of data generated by a client computer. As described herein, “client computers” will be referred to as “frontend computing devices.” Backend computing devices perform such functions as software application processing, data processing, and data storage, wherein each function relates to data generated by frontend computing devices. The backend computing devices connect via networks to a number of frontend computing devices and may share processing functions and storage e areas for the data generated from multiple frontend computers. The frontend computing devices typically receive software applications from one or a group of backend computing devices, or rely on in-built supporting applications, over which a received software application is rendered on the frontend computing device to create a fully functional user interface with a secure communication channel for interacting with the backend computing devices.

A user on the frontend computing device interacts with the user interface, thereby creating new application data on the rendered software application. The software application continuously updates the backend computing device with the new application data generated at the user interface. The application data is processed and stored on the backend computing devices, after which it is transmitted for display to the user via the software application of the frontend computing device. The rendered software application is typically a web-enabled software application accessible to the frontend computing device via a supporting application (e.g., a browser like Internet Explorer® or Mozilla Firefox®) or via a web-enabled stand-alone user-interface support application (e.g., a Java based user-interface application). The immediate benefit of cloud computing processes is the decreased dependency of the software application on the physical and operating system capabilities of the frontend computing device.

Typical functional requirements for the frontend computing devices reduce to such external factors as network connectivity and the user-interface application for interacting with the software application. The user-interface software application typically supports client-side and service-side scripting platforms. While client-side and server-side languages may be interchanged in many current web-based applications, some common examples of client-side web applications may include JavaScript and Hypertext Markup Language (HTML), while Java and Perl are typically considered to be server side scripting languages. A software application created for a cloud environment is typically optimized to function within the requirements of the cloud. Within the cloud environment, provisions for software applications across different VMs for a single business may also lack cross-functional capability in terms of sharing data across software applications, where each software application resides in its own VM.

Many online businesses seek to transfer and customize existing software applications from physical computing devices to a cloud environment. Additionally, cloud service providers play host to the software applications and typically charge fees for delivery of software applications to frontend computing devices, where the software application is standardized for all online businesses that use the software application. Online businesses prefer software applications that are customized by developers to extend the functionality by benefiting from being based in a cloud environment. Such functionalities may relate to how the software application utilizes cloud resources, where cloud application software modules control the administration of cloud resources, including software and hardware provisioning of resources. Customizations require access to the cloud resources, in a programming context, to fully exploit the capabilities of the cloud environment for existing software applications prior to converting the software application for the cloud. Accordingly, information technology service management (ITSM) integration across new and existing cloud components may be limited across different data formats supported by different cloud components from a group of cloud resources.

### SUMMARY

The systems and methods described herein attempt to overcome the drawbacks discussed above by using software adapters to provide integrated information technology service management (ITSM) for cloud resources, where the software adapters convert data format type for the received ITSM function to be executed on a backend computing device, the ITSM function providing management tools for cloud resources underlying a software application.

In one embodiment, a computer-implemented method for integrating information technology service management (ITSM) via software adapters for cloud resources comprises receiving, on a first software application of a first data format type executed on one of a plurality of processors in the cloud resources, at least one ITSM function and at least one input parameter in the first data format from a first computing device, the ITSM function and the input parameter related to management of cloud resources; identifying, on a second software application of a second data format type executed on one of the plurality of processors in the cloud resources, at least one programmable function call for performing an ITSM function in the cloud resources using the input parameter; identifying, by the first or the second software application, a software adapter for transforming the first data format type of the input parameter to the second data format type; executing, the software adapter on one of the plurality of processors in the cloud resources, thereby transforming the first data format type of the input parameter into the second data format type; and executing, in the second software application on one of the plurality of processors in the cloud resources, the programmable function call using the input parameter in the second data format type, thereby performing the ITSM function related to the management of the cloud resources.

In another embodiment, a computer-implemented system for integrating information technology service management (ITSM) via software adapters for cloud resources comprises one of a plurality of processors in the cloud resources configured for executing a first software application of a first data format type for receiving, at least one ITSM function and at least one input parameter in the first data format from a first computing device, the ITSM function and the input parameter related to management of cloud resources; one of the plurality of processors in the cloud resources configured for executing a second software application of a second data format type for identifying, at least one programmable function call for performing an ITSM function in the cloud resources using the input parameter; the first or the second software application for identifying, a software adapter for transforming the first data format type of the input parameter to the second data format type; one of the plurality of processors in the cloud resources configured for executing the software adapter, thereby transforming the first data format type of the input parameter into the second data format type; and one of the plurality of processors in the cloud resources configured for executing, in the second software application, the programmable function call using the input parameter in the second data format type, thereby performing the ITSM function related to the management of the cloud resources.

### BRIEF DESCRIPTION OF THE DRAWINGS

FIG. 1 illustrates a system for integrated information technology service management (ITSM) of cloud resources according to an exemplary embodiment.

FIG. 2 illustrates a system for integrated information technology service management (ITSM) of cloud resources according to an exemplary embodiment.

FIG. 3 illustrates a method for generating programmable function calls for a cloud resource management interface according to an exemplary embodiment.

FIG. 4 illustrates a system for integrated information technology service management (ITSM) of cloud resources according to an exemplary embodiment.

FIG. 5 illustrates a method for integrated information technology service management (ITSM) of cloud resources according to an exemplary embodiment.

### DETAILED DESCRIPTION OF THE EMBODIMENTS

Software applications for frontend computing devices can be ported to a virtual machine (VM) by converting the current operating system (OS) instance that performs the platform functions for the software application into a virtual machine image. In an example, the platform functions perform the hardware side processes for messages or signals from the overlying software application. The hardware side process may include memory assignment, priority queuing, function loading, and application execution among other functions required to render the software application and perform the user input functions. The process of conversion of a software application from a physical device to a VM initiates with an analysis of the physical computing device requirements from the software application perspective. The analyses focuses on the OS usage for the intended software application, including such information as the central processing unit (CPU) allocated, temporary memory (RAM) allocation, hard drive memory used, network information, and other connected hardware information (e.g., drivers, file systems, memory allocation, passwords, etc).

The information from the analyses of the resource usage is representative of how the OS on a physical device supports the overlying software application. The process of porting of the software application requires understanding of the resource allocation from the analysis performed on the OS and hardware. The analyses of the OS and/or hardware usage information results in the creation of emulated native code, which replicates the hardware function allocation performed by the OS. The emulated code compiles or interprets on an emulator which serves as a virtual machine OS (VMOS) platform to interpret or compile any software application data and software application that renders within the VMOS platform into native machine code according to the requirements of the physical computing device that runs the VMOS. This process allows an OS and its related software applications to function as a virtual image on any computing device, with any type of hardware components, and within any other existing operating system environment.

Computing devices and their respective operating systems (OS) may also support Java based user-interface applications for cloud computing on the client-side. In such applications, the Java based user-interface is a stand-alone web-enabled support application that communicates via standard internet protocol (IP) to remote devices over the internet, without the need for a browser. Cloud computing software applications render within the support application on the frontend computing device, thereby providing the user with a user interface to the backend software application. By way of an example, a software application can render as a user interface image on a stand-alone support application (e.g., a Java application, or Python using Glade to design a user interface window) or a dynamic scripting language data file such as, a dynamic hypertext markup language (DHTML) script, on a browser-type support application (e.g., Firefox® browser and Chrome® browser). The software applications in a cloud environment are usually defined within the cloud environment, where backend computing devices share physical hardware devices to host and process data. The cloud environment defines security of shared hardware space and supports scalability of resources based on user demands. Conversion of a software application from a physical environment to a cloud computing environment requires complex configuration changes including the retention of the underlying VM configuration in a shared physical space.

In an exemplary embodiment, a method and system of generating and using programmable function calls for a cloud resource interface is described, where application programming interface (API) functions isolate the cloud resources from the backend software capabilities. This process allows software application developers to access API functions for cloud resource control while creating software applications, thereby extending the functionality of the software application within the cloud environment. API functions control such exemplary functionalities of cloud based software applications as, re-allocation of cloud resources depending on the software application's requirements and monitoring resource usage during deployment of the software application to multiple users. The software platform independence allows external developers to reference the APIs irrespective of the type of cloud resource software which controls the resource allocation functions within the cloud environment. Further, technical, and business related purposes may be cause for modification or even replacement of the cloud resource software technologies without affecting the development process as the API functions are independent of the system software requirements.

The APIs can include the functionalities of third party cloud applications that are deployable in support of the cloud resource functions. Such applications may include resource provisioning applications, service provisioning applications, virtualization technology, or service management frameworks. In an exemplary embodiment, the use of API functions to create in-built responses within the software application can eliminate the need for manual user intervention for modifying software applications in control of the cloud resources. The built-in responses in the software application may automatically initiate an API program call to allocate resources from the cloud based on the pre-defined service level agreements (SLAs) set between the software application developers and the cloud service providers. Exemplary APIs can include functions for retrieving machine discovery information and machine attributes, and for initiating machine start and stop processes.

The API functions can provide access to orchestration tools of the cloud platform. The orchestration tools are a collection of automated software functions that invoke one of several underlying cloud resource component functions such as, a cloud provisioning function, service validation and tracking functions, and a cloud conditioning function. The provisioning function may be internally or externally developed software codes for performing provisioning operations on different computing resources, including hardware, software, or personas of VM images. Internal or external APIs refer to API developed by the cloud service provider or an external service provider respectively, where the external service provider provides certain cloud related software tools that manage certain cloud resource components. The cloud resource components are typically computer-coded software which render on the cloud computing server provider's backend computing devices, thereby controlling the cloud resources available to particular software applications.

The API orchestrating functions may include an API function for virtual machine provisioning and another API function for physical device provisioning. Alternatively, the service provider can define API functions for generic provisioning processes, irrespective of the type of the provisioning software used to perform the actual provisioning of resources. The API functions for orchestration can include cloud conditioning API functions, which includes software codes for integrating a provisioned VM image with other selected infrastructure to enable full functionality of a software application resident within the VM image. The cloud conditioning API function can provide the supporting device driver software codes, stealth drivers, network agents, and other related software codes that allow the VM image to render the software application, process the application data, store the application data, and transfer the application data remotely over the internet. The software application may call cloud orchestration API functions when the application renders for the first time on the VM image.

When a user of the software application opens the software application on a supporting application (e.g., browser window) at a frontend computing device, the software application renders as a user-interface image or a user-interface software coded file (e.g., DHTML file with default data) depending on the type of supporting application being used. Upon initiation at the backend computing device, the software application deploys on a VM image and immediately renders embedded API function calls to initiate the VM image related functions such as, resource allocation functions and software code integration functions to enable full functionally of the software application on the underlying VM image. Additional API functions then deploy for monitoring resource usage on the backend computing devices. When there are additional instances of the software application requested by different users on different frontend computing devices, then multiple VMs imitate, each VM with its own instance of the software application, with certain embedded API functions interacting with each other to provide combined resource usage information.

Multiple instances of the software application may initiate on a single VM image, in which case, an API function embedded with the VM image may provide monitoring and provisioning of the backend resources depending on the VM image requirements. The API function library can include service request validation and tracking API function definitions. The service request validation and tracking API function performs the role of a compliance agent, which monitors and authenticates cloud service subscribers, and automatically initiates the provisioning API function call to allocate resources for the software application, or change resources based on the frontend computing device user request loads.

A VM server provisioning stack API function is defined with the orchestration API function options, where the VM server provisioning stack API function is responsible for provisioning of VM servers in various virtualization technologies supported in the cloud resources. The VM server provisioning stack API function may initiate for the software application instances depending on the structure set by the software application developer. A desktop provisioning stack API function can provide software application developers with options for provisioning virtual desktops in a cloud environment. A virtual desktop typically offers a dedicated OS virtual image from a backend computing device, where certain API functions save changes made to the OS and desktop for future use. In comparison, the use of VM servers provides a cloud environment for software applications that render within each VM server instance.

API functions under the orchestration API function library can include information technology service management (ITSM) framework APIs. In one example, the ITSM framework API functions includes information on the cloud components and their relationships with each other available, where all the information incorporates in a configuration management database (CMDB). A software application developer can use this API to access component information and make cloud configuration changes to support a software application within the description of an SLA. Other exemplary API functions include platform configuration database API functions and network management information functions for securing network configuration information available within the cloud resources.

The ITSM framework integration into the orchestration function library provides capabilities for developers of the software application, executed on the cloud resources, to receive real-time information and support in terms of physical and virtual components usage of the cloud resources over which the software application is executed. Additionally, developers may query the ITSM framework for information, request orders, and check status of service requests and cloud components. Developer requests to the cloud based ITSM framework may include requests for cloud component installation, configuration information requests, or requests related to the SLA. The configuration of cloud components supporting the developer's application resides in the configuration management database (CMDB) and any changes made to the components are also stored within the CMDB to ensure consistent and updated information on the cloud components underlying the developer's application. The ITSM allows developers to request such services as scalability and virtualization of physical and virtual components via a simple ITSM interface. Further, the ITSM component for integration with the cloud resources interface may be a an external third-party ITSM software application with related CMDBs, the external ITSM framework provides APIs, which are made available to the existing cloud platform orchestration framework, to be integrated with existing components, like the VM and desktop provisioning components, the provisioned image conditioning component and server requesting, validating, and tracking components.

The ITSM may also provide developers with continuous status updates and estimated service schedules for such services as incident management and resolution, planning, implementation, deployment, and monitoring of software applications, where each of these services are provided with tight integration to the orchestration function. This allows developers to analyze current resource management statistics, deployment issues, system management issues, service delivery issues etc. In an exemplary embodiment, the ITSM service component may be created, retrieved, updated, and deleted via catalog managers in the ITSM framework. The ITSM receives requests from developers for service via a web interface of the software application developers website, which in turn accesses in the cloud resources interface

The cloud platform orchestration framework integrates the service requests with other cloud resource management interface components to identify the target of the service request. The information related to the received service request is retrieved from the CMDB via API calls to the external ITSM framework, using the APIs defined by the external ITSM software application and made available for integration with the existing software components of the cloud resources. A graphical interface may be provided via the web interface for the developer to provide service request inputs. The inputs may be compared with internal service descriptions and a description of the underlying service component, which is target of the service request is obtained from the ITSM database. Further, configuration data associated with the underlying service component based on the SLA and the cloud resources provided to the developer is retrieved from the CMDB. The configuration information, service component description, and the service description, each responsive to the service request is provided to the developer in a detailed report. The detailed report may be a graphical interface response, an email, or any external notification methods that is integrated into the cloud resource interface.

The configuration data can provide information on the relationship of certain cloud resource components, e.g., databases, multi-tier servers, and networks, where the network may be the developer's network within the cloud resources. The configuration data associated with a developer or a service component is provided an identifier for identification within the CMDB. In an exemplary embodiment, the integration of an existing or a new ITSM framework, as a cloud resource component, includes the deployment of a software adapter. An adapted is a software component that converts data format across software applications into acceptable data format for different software applications. Accordingly, the adapter converts data from one data format type for a newly integrated cloud component to a different data format type for an existing cloud component, or a standard software form, acceptable across multiple new or existing cloud components. Accordingly, in an exemplary embodiment, an extensible markup language (XML) based documenting script may be used as an adapter from a web-based cloud component to the ITSM components. Web service definition language (WSDL) is an exemplary documenting script that can be used for ITSM adapters. A software adapter between a first and second software component may be designed to accept inputs from an first software component, where the inputs are then used within the software adapter to invoke a function call in the second software component to perform the operation requested by the first software component.

The software adapter for the ITSM component of a cloud resources can include a messaging module, e.g., simple access object protocol (SOAP), which may be implemented in XML for accepting inputs and an operation from a first software component, where the operation is to be performed by a second software component using the inputs as the operation data. In the cloud resources, the ITSM component adapter allows interaction between new and existing cloud components of the cloud using the internal APIs of the new and existing cloud components. By way of an example, the ITSM component stores and updates the developer's service requests and statues of the various service tickets raised by a submitted problem or incident report in the CMDB. An integrated database in the cloud resource may include provisioning, scaling and conditioning information of the cloud resources underlying the same developer's applications. Since the provisioning, scaling, and conditioning processes are dynamic in a cloud, the ITSM component can be triggered to any changes occurring in each of the cloud resources via the cloud resource components, thereby keeping the service information for the cloud components as updated as possible. Accordingly, the cloud resource components may invoke APIs of the ITSM component using the software adapter to interact with the ITSM when changes occur or when changes are implemented by manual intervention.

The adapter provides options to the cloud components to retrieve and to store ITSM data via such exemplary computer scripting languages as Java, JavaScript Object Notation (JSON) and XML. Further, in an exemplary embodiment, structured query languages (SQL) may be used to query the ITSM CMDB from external cloud components, where the CMDB responses are packaged into the appropriate data type for the cloud ITSM component, but are packaged into XML or other web-based scripts for delivery to the querying cloud component. In an exemplary embodiment, the adapter for the ITSM framework is computer coded software as a message type middleware using Java RMI (Remote method invocation), or remote .NET tools. The ITSM adapter uses internal or external catalog managers depending on the type of cloud component to convert service requests to the appropriate query type for the CMDB. The catalog manager provides mapping information for mapping received service requests with service descriptions, module descriptions, and configuration data from the respective databases or a combined database. The mapping may be implemented via plain XML, WSDL, or a dedicated business process language for web-based services.

The ITSM component, including the ITSM integration and adapter sub-components perform a service desk and ITSM management, including, service support function, a service desk or a service request function, an incident management function, a problem management function, a change management function, a release management function, a configuration management function, a service level management function, a service delivery function, a capacity management function, an information technology service continuity management function, an infrastructure management function, a software asset management function, and a security management function. Each of these ITSM processes and functions are well known to one of skill in the art of ITSM and information technology infrastructure library (ITIL) concepts. The inputs for incident creation and problem reporting are provided via inputs in a browser or web-enabled stand-alone application on the software application developer's frontend computing device. The service requests are processed via the cloud platform orchestration framework that passes the service requests to the adapter of the ITSM integration component. In an exemplary embodiment, the cloud platform orchestration framework invokes the ITSM integration component to execute logic rules and mapping information that in turn invoke APIs from the adapter for receiving the service description, module description and configuration data. Updates to the incident or problems are provided to the respective sub-components for storage in the CMDB.

The data format types for conversion by the software adapter include formats defined by storage or compression structure, e.g., Hypertext Markup Language (HTML), XML, SQL, etc. Further, data format types may also include operating system (OS), and hardware specific format types, that may be supported by specific combinations of hardware and software. By way of an example, Windows®, iOS®, and Linux® render data differently according to the specific format of the data for each of these exemplary OSs.

Testing of software applications on cloud resources occurs by implementing the API functions disclosed above to create testing and monitoring application that is capable of sharing data with a test software application. The testing and monitoring application can be implemented to test various resource configurations and to monitor resource management for the test software application. Alternatively, the test software application can include embedded API functions for testing, while reporting its own usage data to the system tester. The use of API functions from the cloud resources allows the testing and monitoring application to receive usage information from the test software application, and to introduce resource changes to optimize the test software application functions. Further, the testing and monitoring application can be used to replicate multiple users' requests from the test software application, where each user request is synonymous with real-time live deployment of the test software application for cloud resources.

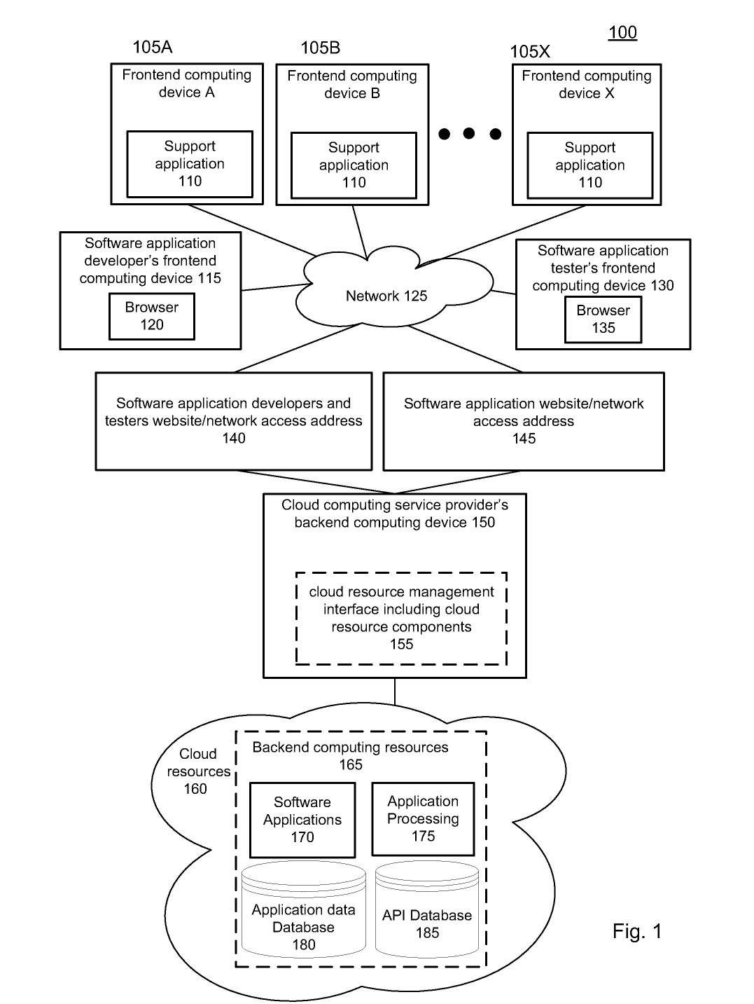

FIG. 1 illustrates a system 100 for integrated information technology service management (ITSM) of cloud resources according to an exemplary embodiment. A software application developer uses a frontend computing device 115 to communicate with a cloud service provider's website for developers 140. The website 140 is available to developers and testers 115, who may remotely develop software applications, control cloud resources, and perform quality assessment (QA) tests on new software applications. The developers and testers' website 140 present developers with a user-interface for developing and testing software application, as well as, arranging cloud resource configurations for new and existing cloud based software applications. The cloud resource management interface 155 may execute and control the cloud resources 160 while being resident within the cloud resources 160. Accordingly, the cloud resource management interface 155 utilizes one of a number of processors in the cloud resources 160 to perform various resource management functions.

API functions created by the cloud service provider for software application developers and testers are stored in an API database 185. Alternatively, the API functions may be stored in the service providers' backend computing device 150. Developers and testers may also access API functions within the developers' website 140, where the API functions provide code level platform access to the components forming the cloud resource management interface 155 on the cloud service provider's backend computing device 150. The backend computing resources 165 form the cloud resources 160 and are used for storing computer-codes software files for new and existing software applications 170 generated by the software application developer, as well as the application data generated from the software application and API functions generated by the cloud service provider. Further, backend resources 160 include various types of virtual computing resources, including different virtual machines platforms, and physical backend computing devices, including storage devices, routers, and network devices. The backend computing devices for the service provider 150, as well as the cloud resources 160, may include multi-tier server devices, such as, web-tier servers, application-tier servers, and database-tier servers, where each server type can be differentiated by their respective storage, processing, and application capabilities. An application data database 175 stores initial default application data for a new user or last stored application data from the last use for a repeat user.

The API functions developed by the service provider are stored within an API database 185 in the cloud resources 160. When a user of a frontend computing device 105 uses a support application 110 (e.g., a browser or a stand-alone cloud computing viewer, like a Java based viewer), one of a chosen software application 170 resident in the cloud resources 160 is retrieved in a script format for rendering on a VM device on the backend computing resources 165. A user-interface image or a user-interface computer coded software file associated with the software application may be sent to render on the support application 110 of the user's frontend computing device 105. When the user on the frontend computing device 105 opens the software application website 145 on a browser window 110 (where the support application is a browser), the user-interface computer-coded software file (e.g., a DHTML) file from a software application storage 170 generates a user-interface webpage with cloud resource components arranged in pre-defined areas on the DHTML webpage.

Any changes made by the user to the DHTML webpage is automatically transmitted via network 125 to the backend computing resources 165, and particularly, to the software application running over a VM on the resources 165. As a failsafe, the changes made by the user simultaneously save into the application data database 180 periodically, so that the user does not lose any work input. A software application tester may use frontend computing device 130 and a supported browser 135 to access the developers and testers website 140 for access to the cloud resource management interface 155. The network address access 140, 145 represent a direct secure login method that can be applied to stand-alone web-enabled applications, e.g., Java, Perl, and Python based applications used to access the cloud resource management interface 155, without the need for a browser.

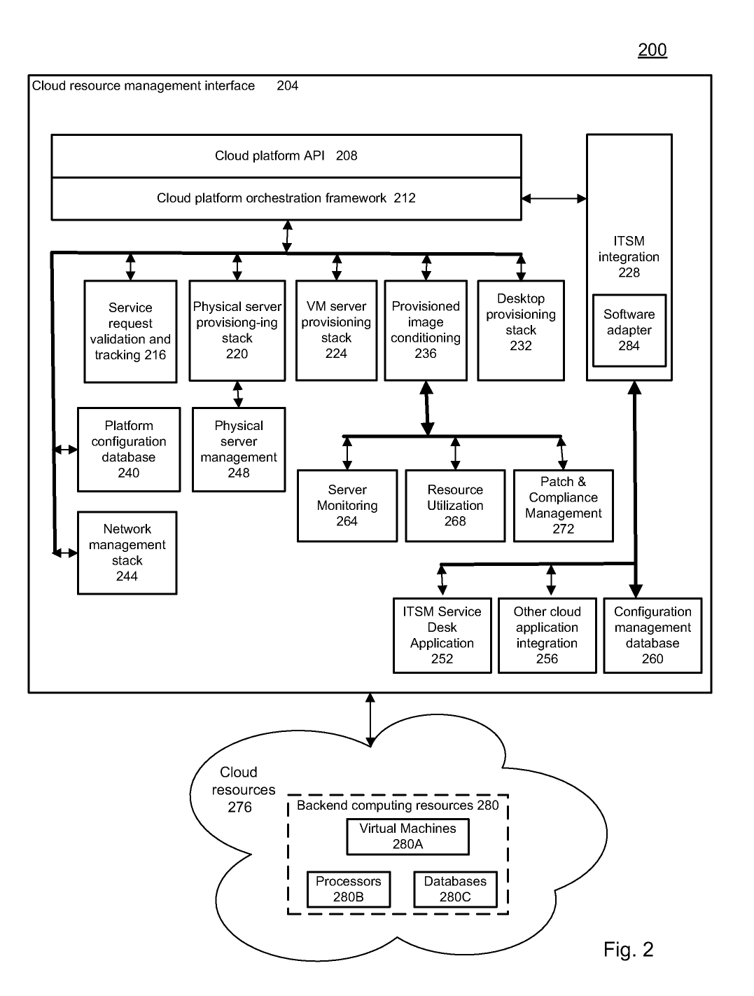

FIG. 2 illustrates a system 200 for integrated information technology service management (ITSM) of cloud resources according to an exemplary embodiment. A cloud resource management interface 204 provides developer access to cloud resource components 212, including sub-components 216-272 via a graphical user-interface. For developers seeking to extend the ability of software applications, the cloud resource components 212 and its sub-components 216-272 can be made available via API functions, shown in FIG. 2 as a cloud platform API 208. The cloud platform APIs are data formats stored in backend computing resources 280 of a cloud resources 276. The backend computing resources 280 includes a number of virtual machines 280A configured to execute sub-components or components 212 and 216-272 via underlying physical processor 280B. Alternatively, the cloud platform APIs may be stored on the cloud service providers' backend computing device 150, as illustrated in FIG. 1. The backend computing resources 165 or 280, and the service provider's backend computing device 150 may be physical processors over which multiple virtual machines may execute. Further, the processors may access databases 280C to store and retrieve information related to the cloud resources 276 or the cloud resource management interface 204. While the cloud resource management interface 204 is illustrated separate from the cloud resources 276, the cloud resource management interface 204 may execute and control the cloud resources 276 while being resident within the cloud resources 276. Accordingly, the cloud resource management interface 204 utilizes one of a number of processors in the cloud resources 276 to perform various resource management functions.

In an exemplary embodiment, the cloud platform APIs include additional API function sub-components for control of the cloud resources 206. A collection of the component and sub-components 216-272 API functions form an API library of software data formats that can be made available to a software application developer via the user-interface developers' website 140, in FIG. 1. The user-interface developers' website 140 displays a library of APIs, along with tutorials for using and applying each API into a software application. The software application developer may choose to review the API script prior to implementing it into the software application. Further, the software application developer or a tester may choose to test the software application via the user-interface provided in the developers' website 140 to study the effects of the added API data format. In this exemplary embodiment, the user-interface on the developers' website 140 sends a message to the backend computing device 150 requesting the cloud resources 160 to initiate a VM to render the test software application, and to return results to the developer.

The cloud platform API 208 includes functions for configuring cloud resources, including service request validation and tracking, VM server provisioning, physical server provisioning, desktop provisioning, ITSM integration, provisioned image conditioning, platform configuration database, and network management Further, the API functions may be extended to include such cloud component functions as, physical server management; ITSM service desk applications; server monitoring; cloud-ware integration; CMDB; resource management; and path and compliance management. The API functions include generic data formats that are compile-able on software compilers made available on the cloud resources 276.

In one example, the service request validation and tracking cloud resource API function 216, the VM server provisioning cloud resource API function 224, the physical server provisioning cloud resource API function 220, the desktop provisioning cloud resource API function 232, the ITSM integration cloud resource API function 228, the provisioned image conditioning cloud resource API function 236, and the network management database cloud resource API function 244 can include generic API data formats to communicate service requests from software applications to their respective cloud resource components. The ITSM integration cloud resource includes software adapter 284 for interfacing with other components or sub-components 216-272 of the cloud resource management interface 204. The ITSM integration cloud resource API function 228 also includes programmable function calls to allow users of a software application to communicate with the developer for service and support. The ITSM framework also provides the user with resource usage and status information for the software application. Further, each API function format may communicate with cloud resource components, where the cloud resource components may be developed using various runbook orchestration technologies known in the art.

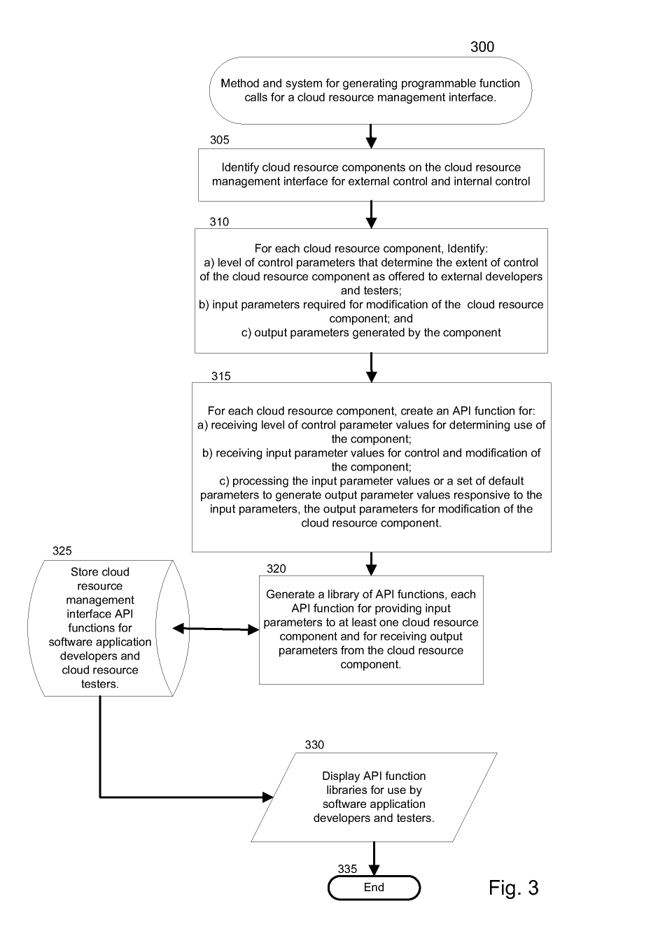

The system of generating programmable function calls for a cloud resource management interface includes determining the level of control the developer may have over each of the cloud resource components 216-272. Accordingly, the cloud service provider may provide varying types of API libraries to certain developers based on the level of control afforded to the developer. In one example, a service level agreement is reached between the developer and the service provider for the level of control over cloud resource components for one or a number of software applications being developed by the developer. The SLA can be converted to computational measurements for automatic verification when an API function is referenced by the developer's software application. Each of the cloud resource components 216-272 executes via one of the many processors in the cloud resources 276. Further, the resource components 216-272 may form separate software applications or may be various software application modules, each component 216-272 forming a module, within a single cloud resource management interface software application 204 that executes via one or more processors in the cloud resources 276 to control the cloud resources 276. In an exemplary embodiment, the cloud resource management interface software application 204 executes as a single software application or as software application modules via one or more virtual machines in the cloud resources 276. The virtual machine compiles the software code from the single software application or multiple software application modules 216-272 into native machine code for one or more physical processors in the cloud resources 276. The level of control information may be referenced with the API function data format as a numeric value or by the permissions assigned to the API function library associated with a chosen software application. FIG. 3 illustrates a method 300 for generating programmable function calls for a cloud resource management interface according to an exemplary embodiment. The cloud service provider identifies cloud resource components in the cloud resource management interface for external control and internal control, as shown in block 305. The external and internal controls refer to a level of control afforded by the SLA to each developer associated with the cloud service provider. The level of control may also be a used to permanently deny modification to certain cloud resource components, thereby preventing developers from accessing them.

An automated computer-coded software may be used to convert SLA settings into level of control values for each of the cloud resource components. Block 310 discloses that after identifying the cloud resource management interface components, the level of control is determined by the SLA, the input parameters for each cloud resource component is identified, and the responsive output parameters are identified. The output parameters are values embedded within computer-coded software that, when transmitted to an API-associated cloud resource component, will trigger modifications of the cloud resource component, irrespective of the type of software platform technology that the cloud resource component uses. In one example, an API function provisioned image conditioning can be used to modify the type of stealth settings on the provisioned image conditioning component for a rendered software application running on the provisioned VM image. The term “parameter” as applicable to “input parameter,” “output parameter,” and “level of control parameter” may refer to a reference tag names used to identity parameter values with computer-codes, where the parameter values provide the actual modifications, or changes in the embodiments herein. The parameter values may be numeric, binary, hex, computer-coded, or even alphanumeric values.

Once the level of control parameters, input parameters, and output parameters have been defined for each cloud resource component of the cloud resource interface, the parameters are processed to create an API function which is responsive to developer requests on the API function input side, and cloud resource component modification on the API function output side. Block 315 is may be a graphical user-interface API editor for generating API functions in such generic programming languages as C or C#. Alternatively, the API functions have a pre-defined structure for each cloud resource component with arguments for inputs and a fixed expected output type. In this exemplary implementation, block 315 would be automated with a software function capable of generating API functions for each cloud resource component from a set of inputs provided to the block.

A completed API function may include an input method, such as an argument input, for receiving input from any software application written by an external software application developer, a level of control parameter value to gauge the level of modification provided to an associated cloud resource component, and an output method to provide modification values in an embedded computer-code, or as plain values to the cloud resource component. Each completed API function is presented in a library of API functions and is stored in an API database (block 325) for use by software application developers and testers. This is illustrated in the exemplary embodiment of FIG. 3, as block 320. The cloud resource management interface that is displayed on a cloud service provider website, upon login by a software application developer, will provide the developer with a link to the list of API functions and tutorials, where applicable, as shown in block 330. The software application developer is restricted to using certain API functions by virtue of login restrictions applicable to the developer based on the developer's SLA with the cloud service provider.

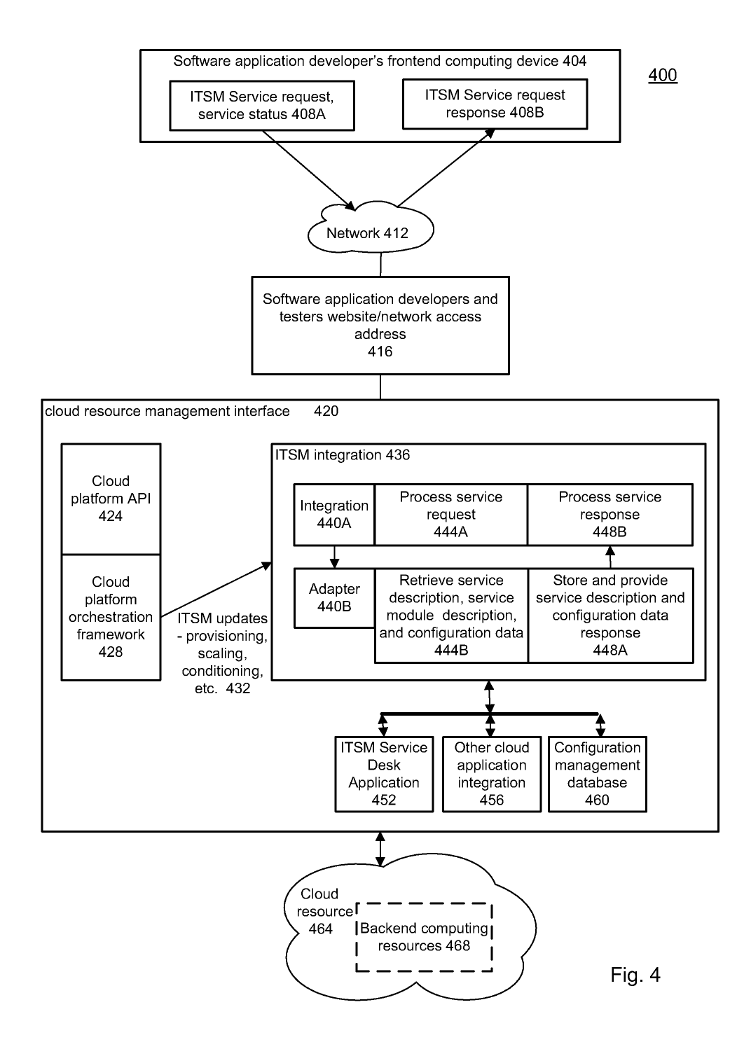

FIG. 4 illustrates a system 400 for integrating information technology service management (ITSM) in the cloud resources using software adapter 440B according to an exemplary embodiment. The software application developer on frontend computing device 404 may provide service desk related requests to the cloud resource management interface 420 via the software application developers' website 416 or a stand-alone application that includes a web-based connection to the cloud resource management interface 420. The cloud resource management interface 420 includes software components and sub-components that manage the ITSM functions of the cloud resources are described in FIG. 2. The cloud platform orchestration framework 428 may cause the ITSM integration component 436 to invoke APIs or provide process requests for updates 432 to the ITSM component 436 based on such functions as scaling, conditioning, and provisioning performed by one of a number of cloud resource components 216-224 and 232-248 of the cloud resource management interface 204, illustrated in FIG. 2.

The service requests and updates from frontend computing device 404 or the orchestration framework 428, may be provided by APIs from the cloud platform APIs 424 or via messaging functions in the ITSM integration 436, using adapters between the ITSM component 436 and the other cloud resource components represented via the orchestration framework 428. The ITSM integration includes the integration section 440A and the adapter section 440B. The service request may be processed using a mapping tool to execute any business process or rules described for each service request. By way of an example, an incident service request regarding a physical server is provided to the ITSM integration, along with an input, the input being an identifier to for the develop, the intended software application, or the cloud computing resource in question. This is received at 444A. The input and the service request is matched to service descriptions in SLA defined business rules, where, when a match allows the software adapter 440B to identify matching programmable functions to use the input and execute within the ITSM component, thereby providing a responsive output to the service request. Associated service module description and configuration data set by the developer or by the SLA between the developer and the cloud service provider is an example of the output that is generated by the ITSM integration component.

The retrieved information is obtained, via system 444B, from the sub-components of the ITSM integration component 436, including the ITSM service desk application 452, the CMDB 460, or any other related cloud application component 456. The retrieved information is either stored in the CMDB 460 and then provided in response to the service request, as illustrated via sub-component 448A. The process service response is provided via the ITSM integration 436 as a response to the developer's query, where the response is an ITSM function output sent to the developer via email, text messages, voice messages, or any other cloud notification method. In an exemplary embodiment, the process service response is an output in the format of management of the cloud resources using ITSM functions for a software application executing on the cloud resources, which may include listing of at least one of service problems, incident reports, configuration settings, capacity settings, service continuity settings, available and in-use software assets, or security settings, wherein each of the listings relate to the cloud resources supporting the software application. The management of cloud resources via the ITSM functions can return cloud resource usage information to the cloud resource management interface, where the resource information may be in the form of reports, settings, and statutes of various components of the cloud resources. Further, the reports, settings and statues may be stored or sent to the service requestor (the developer, in this case), for review.

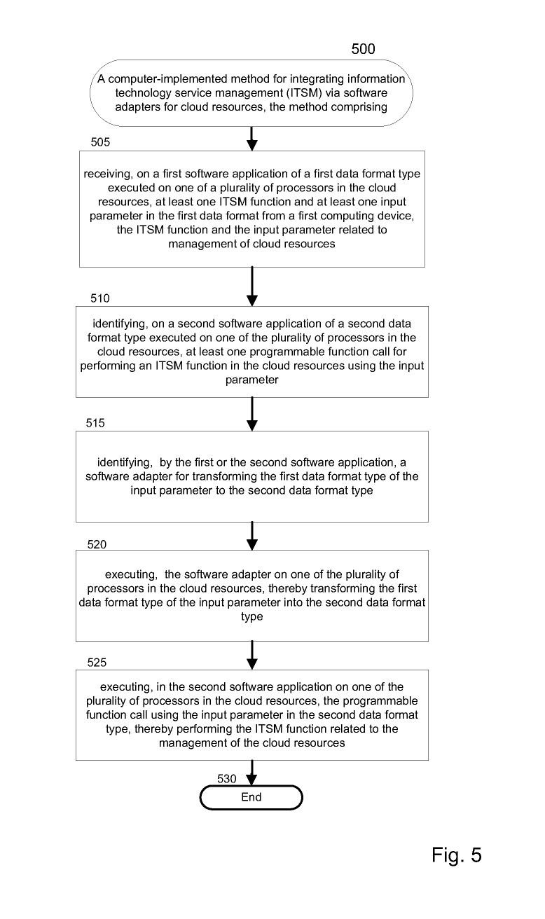

FIG. 5 illustrates a method 500 for integrating information technology service management (ITSM) in the cloud resources using software adapters according to an exemplary embodiment. Block 505 receives, on a first software application, an ITSM function and an input parameter, the input parameter is to be applied to the ITSM function and executed on a second software application, where the second software application includes programmable function calls, e.g., APIs, to perform the ITSM function, and executes one of the number of processors in the cloud resources. The first software application supports a first data format type, while the second software application supports a second data format type. The second software application also executes in one of the processors in the cloud resources. Alternatively, the first and second software applications may execute on a virtual machine, which compiles the software code from the first and second software applications into native machine code of the underlying physical processors in the cloud resources. In an alternate embodiment, the first and second software application may execute outside the cloud resources or in a different cloud resource as a redundancy to prevent failure. In the case of the cloud resources of FIG. 4, the cloud components and sub-components may be of different language implementations, and therefore, of different data format type for the processors and even the virtual machines. Further, the ITSM function may be a request from a developer or a frontend computing device or from the a different cloud component on a computing device that does not perform the ITSM operations.

Block 510 identifies the programmable function call, via the first or the second software application, where the programmable function call is responsive to the ITSM function, where the programmable function call is defined within the second software application. The second software application may be the ITSM retrieving component 444B of system 400. Block 515 identifies an appropriate software adapter to convert the data format type of the input parameter to the appropriate data format type of the second software application, and specifically to the programmable function call of the second software application. The software adapter may execute via one of the processors in the cloud resources or the virtual machines using the same methods described with the first or the second software application. Block 520 performs the computer execution of the identified software adapter, in the processors or the virtual machine of the cloud resources, to convert the data format type of the input parameter to the data format type of the second software application or the programmable function call. The second software application including the ITSM CMDB retrieving application is executed, via block 525 including the virtual machine or the processors, with the programmable function call and using the input parameter in the second data format type, thereby providing an output for the ITSM request received at the first software application.

In an exemplary embodiment, the ITSM request is a service request including a request for incident update, a new incident, a new problem, a new installation request, and any related ITSM request. The ITSM is thereby integrated into the cloud resources via software adapters. The output from the second software application is a report, an email, or a message stating the status of the ITSM request. Block 530 concludes the method 500 for integrating information technology service management (ITSM) in the cloud resources using software adapters according to an exemplary embodiment.

The exemplary methods and systems described in this disclosure are illustrative, and, in alternative embodiments, certain steps can be performed in a different order, in parallel with one another, omitted entirely, and/or combined between different exemplary embodiments, and/or certain additional acts can be performed, without departing from the scope and spirit of this disclosure. Accordingly, such alternative embodiments are included in the inventions described herein.

The exemplary embodiments can be used with computer hardware and software that perform the methods and processing functions described above. As will be appreciated by those having ordinary skill in that art, the systems, methods, and procedures described herein can be embodied in a programmable computer, computer executable software, or digital circuitry. The software can be stored on computer readable media. For example, “computer-coded,” “software,” “scripts,” and “programs” are software codes used interchangeably for the purposes of simplicity in this disclosure. Further, “computer-readable medium,” “memory,” and storage can include such media as, floppy disk, RAM, ROM, hard disk, removable media, flash memory, memory stick, optical media, magneto-optical media, CD-ROM, etc.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for integrating information technology service management (ITSM) via software adapters for cloud resources, the method comprising:
receiving, on a first software application of a first data format type executed on one of a plurality of processors in the cloud resources, at least one ITSM function and at least one input parameter in the first data format from a first computing device, the ITSM function and the input parameter related to management of cloud resources;
identifying, on a second software application of a second data format type executed on one of the plurality of processors in the cloud resources, at least one programmable function call for performing an ITSM function in the cloud resources using the input parameter;
identifying, by the first or the second software application, a software adapter for transforming the first data format type of the input parameter to the second data format type;
executing, the software adapter on one of the plurality of processors in the cloud resources, thereby transforming the first data format type of the input parameter into the second data format type; and
executing, in the second software application on one of the plurality of processors in the cloud resources, the programmable function call using the input parameter in the second data format type, thereby performing the ITSM function related to the management of the cloud resources.

2. The method according to claim 1, further comprising:
transmitting, from one of the first or the second software application, an output of the programmable function call to the first computing device in response to the received ITSM function and input parameter from the first computing device, wherein the output comprises management of the cloud resources.

3. The method according to claim 1, further comprising:
storing, by the second software application in a database in the cloud resources, an output of the programmable function call in response to the received ITSM function and input parameter from the first computing device, wherein the output comprises management of the cloud resources.

4. The method according to claim 1, wherein the first and the second data format type of the input parameter are data formats defined by one of the storage structure or the compression structure of data within the input parameter.

5. The method according to claim 1, wherein the first and the second data format types of the input parameter are data formats executable by one of the plurality of processors in the cloud resources.

6. The method according to claim 1, wherein the ITSM function is one of a service support function, a service desk or a service request function, an incident management function, a problem management function, a change management function, a release management function, a configuration management function, a service level management function, a service delivery function, a capacity management function, an information technology service continuity management function, an infrastructure management function, a software asset management function, and a security management function.

7. The method according to claim 1, wherein the programmable function call is an application programmable interface (API) function call.

8. The method according to claim 1, wherein the management of the cloud resources using the ITSM function includes listing of at least one of service problems, incident reports, configuration settings, capacity settings, service continuity settings, available and in-use software assets, or security settings, wherein each of the listings relate to the cloud resources.

9. The method according to claim 1, wherein first and the second software applications are software modules comprised within a cloud management software application.

10. The method according to claim 1, wherein the first software application, the second software application, and the software adapter are software modules comprised within a single cloud management software application.

11. The method according to claim 1, wherein the first software application, the second software application, and the software adapter execute on a virtual machine, the virtual machine compiling software codes from the first software application, the second software application, and the software adapter to native machine codes of one or more of the plurality of processors in the cloud resources.

12. A computer-implemented system for integrating information technology service management (ITSM) via software adapters for cloud resources, the system comprising:
one of a plurality of processors in the cloud resources configured for executing a first software application of a first data format type for receiving, at least one ITSM function and at least one input parameter in the first data format from a first computing device, the ITSM function and the input parameter related to management of cloud resources;
one of the plurality of processors in the cloud resources configured for executing a second software application of a second data format type for identifying, at least one programmable function call for performing an ITSM function in the cloud resources using the input parameter;
the first or the second software application for identifying, a software adapter for transforming the first data format type of the input parameter to the second data format type;
one of the plurality of processors in the cloud resources configured for executing the software adapter, thereby transforming the first data format type of the input parameter into the second data format type; and
one of the plurality of processors in the cloud resources configured for executing, in the second software application, the programmable function call using the input parameter in the second data format type, thereby performing the ITSM function related to the management of the cloud resources.

13. The system according to claim 9, further comprising:
the first or the second software application configured for transmitting, an output of the programmable function call to the first computing device in response to the received ITSM function and input parameter from the first computing device, wherein the output comprises management of the cloud.

14. The system according to claim 9, further comprising:
a database in the cloud resources for storing, by the second software application in a database, an output of the programmable function call in response to the received ITSM function and input parameter from the first computing device, wherein the output comprises management of the cloud resources.

15. The system according to claim 9, wherein the first and the second data format type of the input parameter are data formats defined by one of the storage structure or the compression structure of data within the input parameter.

16. The system according to claim 9, wherein the first and the second data format types of the input parameter are data formats executable by one of the plurality of processors in the cloud resources.

17. The system according to claim 9, wherein the ITSM function is one of a service support function, a service desk or a service request function, an incident management function, a problem management function, a change management function, a release management function, a configuration management function, a service level management function, a service delivery function, a capacity management function, an information technology service continuity management function, an infrastructure management function, a software asset management function, and a security management function.

18. The system according to claim 9, wherein the programmable function call is an application programmable interface (API) function call.

19. The system according to claim 9, wherein the management of the cloud resources using the ITSM function includes listing of at least one of service problems, incident reports, configuration settings, capacity settings, service continuity settings, available and in-use software assets, or security settings, wherein each of the listings relate to the cloud resources.

20. The system according to claim 1, wherein first and the second software applications are software modules comprised within a cloud management software application.

21. The system according to claim 1, wherein the first software application, the second software application, and the software adapter are software modules comprised within a single cloud management software application.

22. The system according to claim 1, wherein the first software application, the second software application, and the software adapter execute on a virtual machine, the virtual machine compiling software codes from the first software application, the second software application, and the software adapter to native machine codes of one or more of the plurality of processors in the cloud resources.
